(19) United States
(12) Patent Application Publication
(10) Pub. No.: US 2022/0021146 A1
(43) Pub. Date: Jan. 20, 2022

(54) F-TYPE FEMALE PORT WITH SNAP-IN FEATURE

(71) Applicant: Corning Optical Communications RF LLC, Glendale, AZ (US)

(72) Inventors: Søren Baldus-Kunze, Slagelse (DK); Michael Ole Matzen, Vordingborg (DK)

(21) Appl. No.: 17/488,127

(22) Filed: Sep. 28, 2021

Related U.S. Application Data
(63) Continuation of application No. PCT/US2020/024850, filed on Mar. 26, 2020.
(60) Provisional application No. 62/827,837, filed on Apr. 1, 2019.
(60) Provisional application No. 62/896,095, filed on Sep. 5, 2019.

(51) Int. Cl. H01R 13/187; H01R 24/40

(52) U.S. Cl. CPC H01R 13/187; H01R 24/40

(57) ABSTRACT

An F-type female port includes a port outer body, having a first port end and a second port end; an interior cavity disposed between the first port end and the second port end; and at least one interior snap element positioned within the interior cavity. The at least one interior snap element includes at least one snap-in feature having spring-like characteristics that allow the at least one interior snap element to flexibly and retractably engage with a male connector element upon mating of the male connector element with the F-type female port.

### RELATED APPLICATIONS

This application is a continuation of International Application No. PCT/US2020/024850, filed Mar. 26, 2020, which claims the benefit of priority to U.S. Application Ser. No. 62/827,837, filed Apr. 1, 2019, and U.S. Application Ser. No. 62/896,095, filed Sep. 5, 2019, the contents of which are relied upon and incorporated herein by reference in their entireties.

### BACKGROUND

The present disclosure generally relates to F-Type female ports, and particularly F-Type female ports having one or more snap-in features that facilitate connection to a mating male connector element.

F-Type ports are components of F-type connectors, which are commonly used in the “drop” end of a network installation with high frequency signals. Many F-type female connectors have a threaded design, but the threads are included on the male part. While threaded designs offer many advantages, these designs can cause complications. Such complications include, but are not limited to, threads becoming broken, threads not being matched correctly with mated components, etc.

The invention, as claimed and disclosed herein, overcomes the aforementioned complications and provides other related advantages.

### SUMMARY

Disclosed herein are embodiments of F-type connector components that include an F-type female port connector element, having one or more snap-in features. The overall design of the F-type connector components is such that the respective mating components are sufficiently mated preferably without the use of tools. The F-type connector components are also preferably mated such that the F-type female port is configured to be in its most rested state when fully assembled. The particular designs of the F-type female ports disclosed herein can be such that the female port is configured to mate with male connector components, having damaged threads.

To achieve consistent mating with male connector elements, the F-type female ports disclosed herein preferably have “snap” elements. As used herein the term “snap” refer to flexible engagement and disengagement with one or more surfaces that may or may not be curved or contoured. The snap element preferably includes one or more cut-out portions, which enables at least one snap-in feature to have spring-like characteristics, and thus allow a push on F-connector to rest, flexibly engaged and upon removal, flexibly retract or disengaged from a seated position.

The F-type connector elements disclosed herein are also designed such that both new female ports and retrofitted or existing female ports can be mated with male connector elements. The F-type connector female ports are also configurable with known standards or designed for mating with existing components as well as non-standard components.

One aspect of the disclosure is directed to embodiments of an F-type female port, which includes a port outer body, having a first port end and a second port end, an interior cavity disposed between the first port end and the second port, and at least one interior snap element positioned within the interior cavity, wherein the at least one interior snap element comprises at least one snap-in feature having spring-like characteristics that allow the at least one interior snap element to flexibly and retractably engage with a male connector element upon mating of the male connector element with the F-type female port.

Another aspect of the disclosure is directed to embodiments of connector element assemblies including a male connector element and an F-type female port mated with the male connector element. The F-type female port includes a port outer body, having a first port end and a second port end, an interior cavity disposed between the first port end and the second port, and at least one interior snap element positioned within the interior cavity, wherein the at least one interior snap element has at least one snap-in feature having spring-like characteristics that allow the at least one interior snap element to flexibly and retractably engage with a male connector element upon mating of the male connector element with the F-type female port.

### BRIEF DESCRIPTION OF THE DRAWINGS

FIG. 1 is a cross-sectional view of a male connector element having damaged threads, and an F-type female port in accordance with embodiments disclosed herein;

FIG. 2 is a partial cross-sectional view of the male connector element of FIG. 1, having damaged threads, assembled with the F-Type female port of FIG. 1 in accordance with embodiments disclosed herein;

FIG. 3 is a cross-sectional view of a threadless male connector element and an F-type female port in accordance with embodiments disclosed herein;

FIG. 4 is a cross-sectional view of the threadless male connector element of FIG. 3 assembled with the F-type female port of FIG. 3 in accordance with embodiments disclosed herein;

FIGS. 5 and 6 are perspective views of connector assemblies, with each assembly including a seal ring assembled with an F-type female port in accordance with embodiments disclosed herein; and

FIGS. 7 and 8 are side views of various connector assemblies, with each assembly including an F-type female port in accordance with embodiments disclosed herein.

The figures are not necessarily to scale. Like numbers used in the figures may be used to refer to like components. However, it will be understood that the use of a number to refer to a component in a given figure is not intended to limit the component in another figure labeled with the same number.

### DETAILED DESCRIPTION

Various exemplary embodiments of the disclosure will now be described with particular reference to the drawings. Exemplary embodiments of the present disclosure may take on various modifications and alterations without departing from the spirit and scope of the disclosure. Accordingly, it is to be understood that the embodiments of the present disclosure are not to be limited to the following described exemplary embodiments, but are to be controlled by the features and limitations set forth in the claims and any equivalents thereof.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein.

As used in this specification and the appended claims, the singular forms “a,” “an,” and “the” encompass embodiments having plural referents, unless the content clearly dictates otherwise. As used in this specification and the appended claims, the term “or” is generally employed in its sense including “and/or” unless the content clearly dictates otherwise.

Spatially related terms, including but not limited to, “lower,” “upper,” “beneath,” “below,” “above,” and “on top,” if used herein, are utilized for ease of description to describe spatial relationships of an element(s) to another. Such spatially related terms encompass different orientations of the device in use or operation in addition to the particular orientations depicted in the figures and described herein. For example, if an object depicted in the figures is turned over or flipped over, portions previously described as below or beneath other elements would then be above those other elements.

Cartesian coordinates are used in some of the Figures for reference and are not intended to be limiting as to direction or orientation.

For purposes of description herein, the terms “upper,” “lower,” “right,” “left,” “rear,” “front,” “vertical,” “horizontal,” “top,” “bottom,” “side,” and derivatives thereof, shall relate to the disclosure as oriented with respect to the Cartesian coordinates in the corresponding Figure, unless stated otherwise. However, it is to be understood that the disclosure may assume various alternative orientations, except where expressly specified to the contrary.

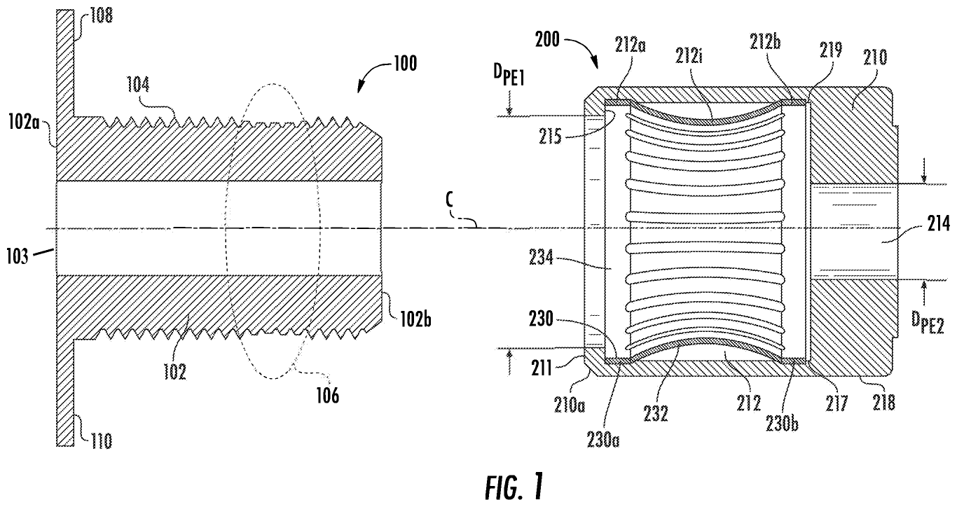

FIG. 1 shows cross-sectional views of a male connector element 100 and an F-type female port 200, which are substantially aligned with respect to a centerline C. The male connector element 100 includes a male connector body 102, having a first body end 102a and a second body end 102b. A thru-hole 103 extends through the male connector body 102, and threads 104 are circumferentially disposed around the male connector body 102 with respect to the centerline C. The threads 104 include a damaged thread section 106. However, in alternative embodiments, threads on the male connector may be free from damage. The male connector body 102 also includes a front-end portion 108 having an extending section 110, which is substantially perpendicular to the male connector body 102.

Still referring to FIG. 1, the F-type female port 200 is shown in substantial alignment with the male connector element 100 with respect to centerline C. The female port 200 includes a port outer body 210, having a first port end 210a and a second port end 210b, and an interior cavity 212, having a first cavity end 212a and a second cavity end 212b. The port outer body 210 also has a substantially smooth outer surface 218.

The first port end 210a is defined, in part, by an inner diameter D_{PE1} such that the first port end 210a has an inwardly extending step element 211. Similarly, the second port end 210b is defined, in part, by an inner diameter D_{PE2} such that the second port end 210b has a bore 214. The bore 214 extends from the second cavity end 212b to the second port end 210b.

The interior cavity 212 extends from a step interior face 215 of the step element 211 to an opposing face 217 of an interior body element 219. The interior cavity 212 has a first cavity end 212a, an inner cavity section 212i, and a second cavity end 212b. The interior cavity 212 is configured to house an interior snap element 230 having at least one snap-in feature 232 with spring-like characteristics that allow the interior snap element 230 to flexibly engage and retractably engage with a male connector element upon mating of the male connector element 100 with the F-type female port 200.

The interior snap element 230 has a first snap element end 230a and a second snap element end 230b. The at least one snap-in feature 232 is preferably disposed between the first snap element end 230a and the second snap element end 230b. The spring-like characteristics of the at least one snap-in feature 232 can result from the properties of the materials used to manufacture the snap elements/snap-in features, e.g. steel, aluminum, and brass and various alloys that include steel, aluminum, and/or brass. Moreover, spring-like characteristics of the interior snap element 230 can result from one or more cut-out portions 234. A cut-out portion 234 in accordance with embodiments disclosed herein preferably extends along the length of the interior snap element 230. Where a plurality of cut-out portions 234 is included in the interior snap element 230, the plurality of cut-out portions 234 preferably is circumferentially and uniformly positioned around an inner surface of the interior snap element 230. The cut-out portions 234 are preferably uniformly positioned, as shown particularly in FIG. 1 and have a concave profile that inwardly curves toward the center of the female port 200.

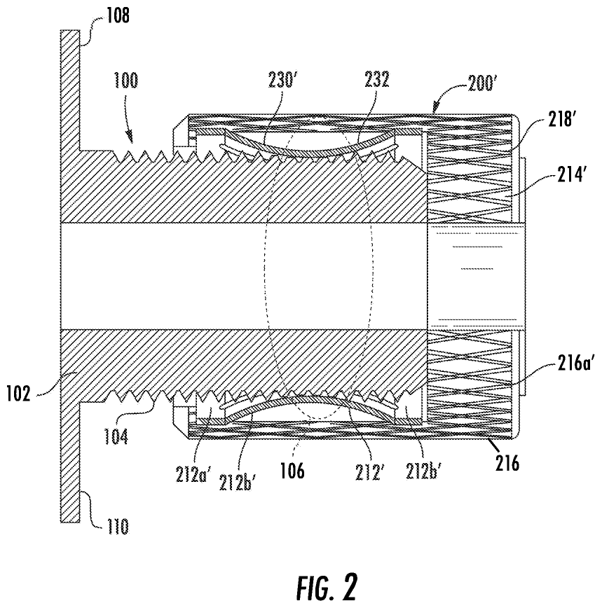

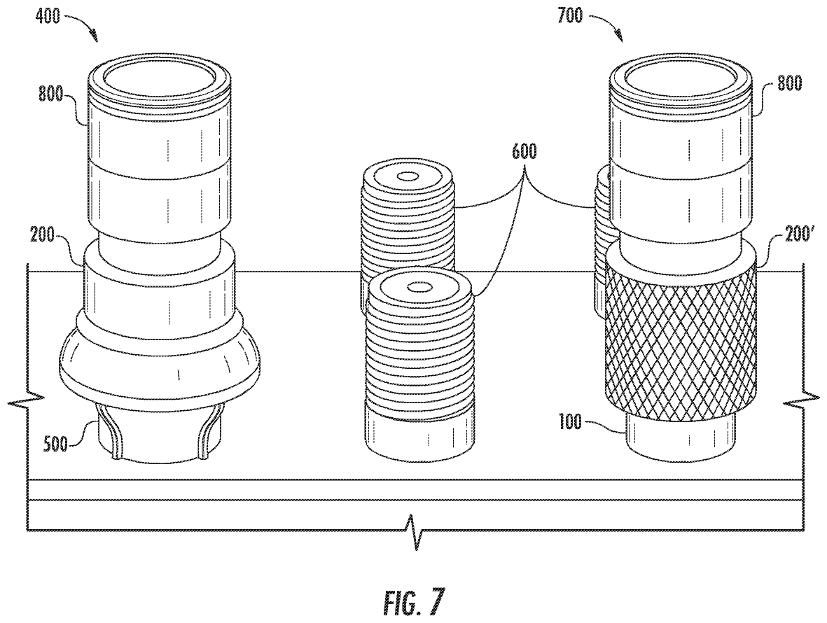

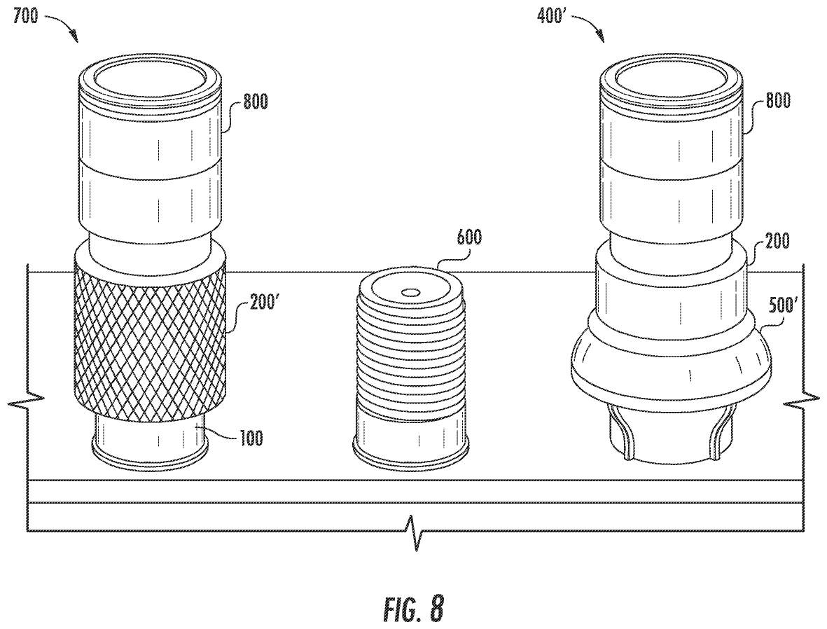

FIG. 2 is a partial cross-sectional view of the male connector element 100 assembled with an F-Type female port 200′. Here, an outer section 216′ is shown, having a knurled-pattern 216a′ on the outer surface 218′ of the port. The interior snap element 230′ is shown engaged with the damaged thread section 106 of the male connector element 100. The interior snap element 230′ may also similarly engage with a damage free male connector element 600, such as those shown in FIGS. 7 and 8.

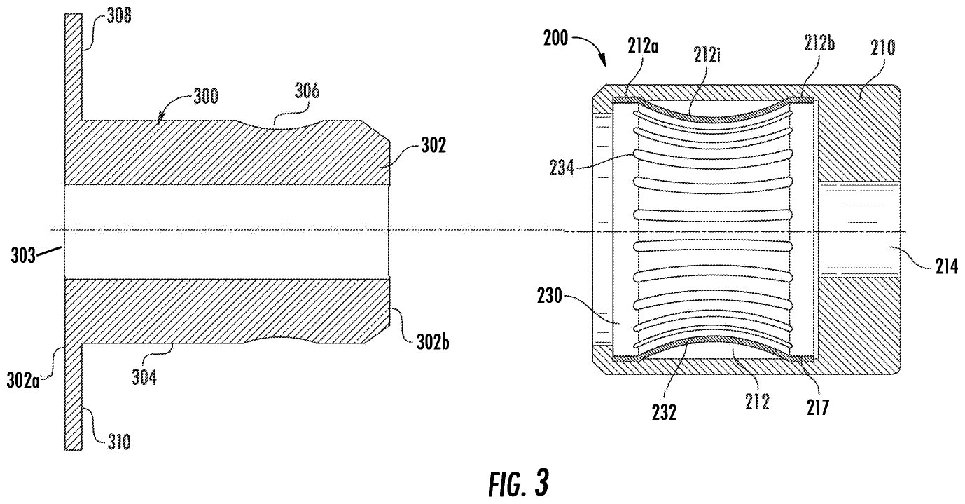

FIG. 3 is a cross-sectional view of a threadless male connector element 300 and the F-type female port 200. The thread-less male connector element 300 has a thread-free body 302 with a thread-less section 306 having a curved profile 309 that inwardly curves toward the center of the male connector element 300. However, in alternative embodiments, the thread-less section 306 may not be included. The thread-less male connector element 300 also includes a first body end 302a and a second body end 302b. A thru-hole 303 extends through the thread-free body 302 and a front-end portion 308 having an extending section 310, which is substantially perpendicular to the thread-free body 302.

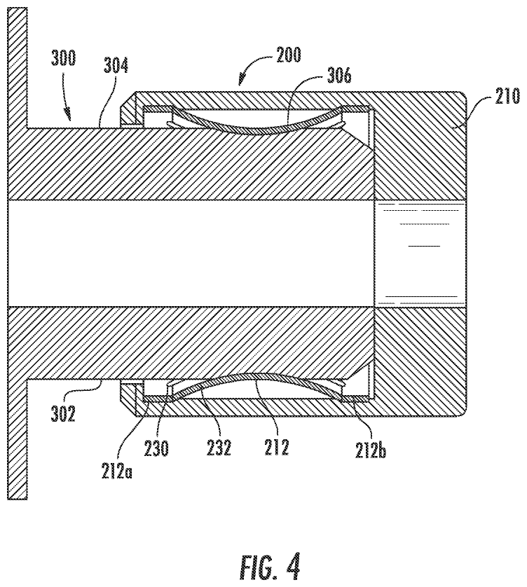

FIG. 4 is a cross-sectional view of the threadless male connector element 300 assembled with the F-type female port 200 and an additional connector element 800.

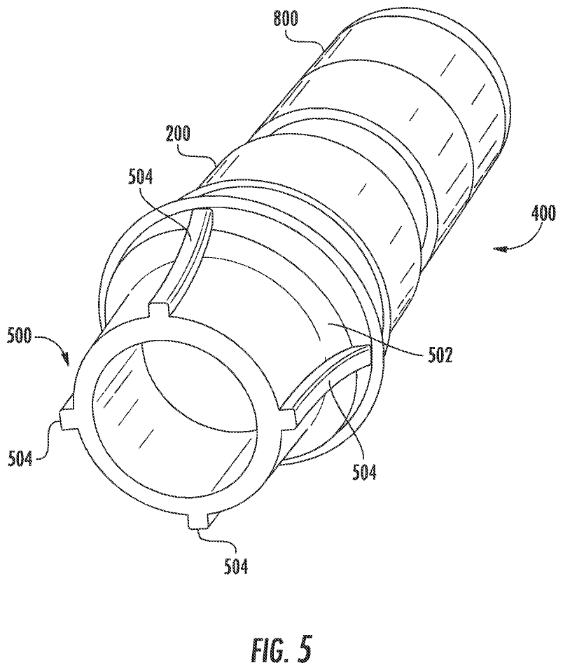

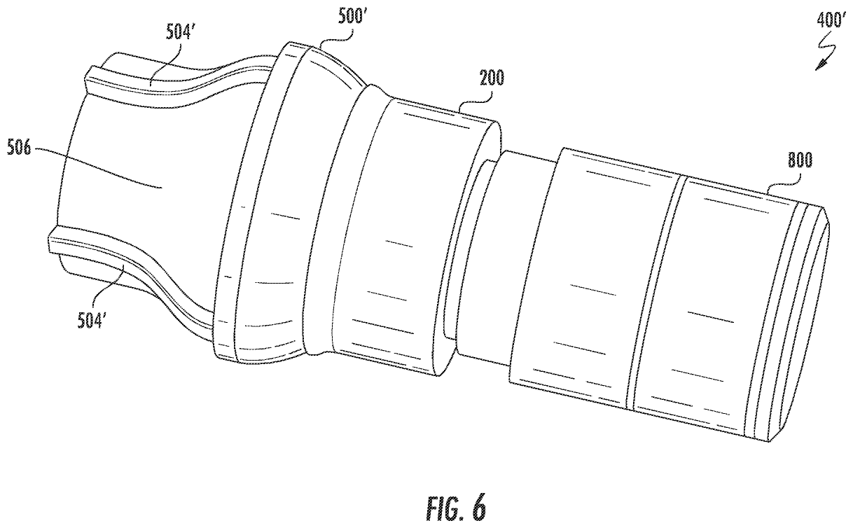

FIGS. 5-8 show various connector assemblies 400, 400′, 700, with each assembly including a seal ring 500, 500′ assembled with an F-type female port 200, 200′. The seal ring 500, 500′ have different profiles with seal ring 500 having a concave outer surface 502 and a plurality of ribs 504 coupled to and uniformly position around the outer surface 502.

Also shown in FIGS. 5-8 are different configurations of male connector elements 600, 800. Preferably, the F-type connector assembly also includes a seal ring 500, 500′ disposed around a portion of the outer body of the F-type connector that will make the connector assemblies 400, 400′, 700 suitable for outdoor installation. Use of the seal rings 500, 500′ in these connector assemblies 400, 400′, 700 can provide for watertight connections with the respective connector elements. The seal ring 500, 500′ can, for example, on a mechanical stop on the outer housing of the connector body. The seal ring 500, 500′ preferably manufactured from one or more elastomeric materials that allow the ring to conform to mating surfaces. Alternatively, or in addition, the seal ring 500, 500′ may be positioned onto the connector assembly 400, 400′, 700 with an adhesive or a mechanical connector.

Materials used to manufacture the snap-in feature and other connector elements disclosed include, but are not limited to ferrous and aluminum based materials.

It will be apparent to those skilled in the art that various modifications and variations can be made without departing from the spirit or scope of the disclosed embodiments. Since modifications combinations, sub-combinations and variations of the disclosed embodiments incorporating the spirit and substance of the embodiments may occur to persons skilled in the art, the disclosed embodiments should be construed to include everything within the scope of the appended claims and their equivalents.

What is claimed is:

1. An F-type female port, comprising:
a port outer body, having a first port end and a second port end;
an interior cavity disposed between the first port end and the second port end; and
at least one interior snap element positioned within the interior cavity, wherein the at least one interior snap element comprises at least one snap-in feature having spring-like characteristics that allow the at least one interior snap element to flexibly and retractably engage with a male connector element upon mating of the male connector element with the F-type female port.

2. The F-type female port of claim 1, wherein the at least one interior snap element comprises a first snap element end and a second snap element end, and wherein the at least one snap-in feature is positioned between the first snap element end and the second snap element end.

3. The F-type female port of claim 1, wherein the at least one interior snap element comprises at least one cut-out portion extending along the length of the at least one interior snap element.

4. The F-type female port of claim 1, wherein the at least one interior snap element comprises a plurality of cut-out portions positioned circumferentially around an inner surface of the at least one interior snap element.

5. The F-type female port of claim 1, wherein the interior cavity comprises a first cavity end and a second cavity end.

6. The F-type female port of claim 5, wherein the port outer body comprises an inwardly extending step element adjacent to the first cavity end.

7. The F-type female port of claim 5, wherein the port outer body includes a bore extending from the second cavity end to the second port end.

8. The F-type female port of claim 3, wherein the at least one cut-out portion inwardly curves toward the center of the F-type female port.

9. The F-type female port of claim 1, wherein the port outer body has an outer surface with a knurled pattern.

10. The F-type female port of claim 1, wherein the port outer body has a substantially smooth outer surface.

11. A connector element assembly, comprising:
a male connector element; and
an F-type female port mated with the male connector element, comprising:
a port outer body, having a first port end and a second port end,
an interior cavity disposed between the first port end and the second port, and
at least one interior snap element positioned within the interior cavity, wherein the at least one interior snap element comprises at least one snap-in feature having spring-like characteristics that allow the at least one interior snap element to flexibly and retractably engage with a male connector element upon mating of the male connector element with the F-type female port.

12. The connector element assembly of claim 11, wherein the at least one interior snap element comprises a first snap element end and a second snap element end, and wherein the at least one snap-in feature is positioned between the first snap element end and the second snap element end.

13. The connector element assembly of claim 11, wherein the at least one interior snap element comprises at least one cut-out portion extending along the length of the at least one snap-in feature.

14. The connector element assembly of claim 11, wherein the at least one interior snap element comprises a plurality of cut-out portions positioned circumferentially around an inner surface of the at least one interior snap element.

15. The connector element assembly of claim 11, wherein the interior cavity comprises a first cavity end and a second cavity end.

16. The connector element assembly of claim 15, wherein the port outer body comprises an inwardly extending step element adjacent to the first cavity end.

17. The connector element assembly of claim 15, wherein the port outer body includes a bore extending from the second cavity end to the second port end.

18. The connector element assembly of claim 13, wherein the at least one cut-out portion inwardly curves toward the center of the F-type female port.

19. The connector element assembly of claim 11, wherein the port outer body has an outer surface with a knurled pattern.

20. The connector element assembly of claim 11, wherein the port outer body has a substantially smooth outer surface.
